(19) United States
(12) Patent Application Publication
(10) Pub. No.: US 2015/0095482 A1
(43) Pub. Date: Apr. 2, 2015

(54) Method and System for Deploying Service in a Cloud Computing System

(71) Applicant: International Business Machines Corporation, Armonk, NY (US)

(72) Inventors: Yang Che, Beijing (CN); Jin Gui Ying, Beijing (CN); Tong Li, Beijing (CN); Xi Ning Wang, Beijing (CN); Yu Zhang, Beijing (CN); Chen Ting Zhao, Beijing (CN)

(21) Appl. No.: 14/484,431

(22) Filed: Sep. 12, 2014

(30) Foreign Application Priority Data
Sep. 29, 2013 (CN) 201310454664.0

(51) Int. Cl. H04L 12/24

(52) U.S. Cl. CPC H04L 41/50
USPC 709/223

(57) ABSTRACT

A method and system for deploying a service in a cloud computing system. The method comprises collecting metadata information related to the service, building a list including a plurality of potential service endpoints by using the metadata information, and validating the potential service endpoints in the list. With the method, mapping between service and service endpoints is effectively processed while deploying the service.

### CROSS REFERENCE TO RELATED APPLICATION

This application claims the benefit of priority from Chinese Patent Application No. 201310454664.0 filed on Sep. 29, 2013, the entirety of which is incorporated by reference.

### FIELD OF THE INVENTION

The present invention relates to cloud computing, more specifically to a method and system for deploying a service in a cloud computing system.

### BACKGROUND

Platform as a Service (PaaS) is a category of cloud computing for providing a middleware service and a service at a solution level. In a service model of PaaS, a cloud service provider deploys a service in software instances for providing capabilities of middleware to users. Generally, to deploy a service into software instances, it is required to determine a service endpoint of the service. The service endpoint is an address for a user to use the service, which typically includes a combination of an IP address and a port of the service. However, since the port of the service is only known by software itself during deploying the service in a cloud computing system, how to process mapping between the service and the service endpoint is a challenge currently faced in the art.

There are generally three methods in the art. However, none of them can effectively process mapping between the service and the service endpoint. The first method is to develop a detection plug-in directed to specific software configuration; such as, the detection plug-in directed to configuration file of Tomcat (which is an open source web server and servlet container developed by the Apache Software Foundation). However, since the detection plug-in cannot be reused among different software configurations, different detection plug-ins must be developed for different software configurations. The second method is a hard code service endpoint; however, this method will lead to waste of computation resource. The third method is to perform network virtualization, which virtualizes IP addresses of the service; however, this method will significantly affect network performance.

### SUMMARY

Embodiments of the present invention provide a method for deploying a service in a cloud computing system. The method comprises: collecting metadata information related to the service; building a list including a plurality of potential service endpoints by using the metadata information; validating the potential service endpoints in the list.

Embodiments of the present invention provide a system for deploying a service in a cloud computing system. The system comprises a collecting unit configured to collect metadata information related to the service, a building unit configured to build a list including a plurality of potential service endpoints by using the metadata information, and a validating unit configured to validate the potential service endpoints in the list.

### BRIEF DESCRIPTION OF THE SEVERAL VIEWS OF THE DRAWINGS

FIG. 1 is a diagram illustrating a cloud computing node, in accordance with one embodiment of the present invention.

FIG. 2 is a diagram illustrating a cloud computing environment, in accordance with one embodiment of the present invention.

FIG. 3 is a diagram illustrating abstraction model layers, in accordance with one embodiment of the present invention.

FIG. 4 is a diagram illustrating a flowchart for deploying a service in a cloud computing system, in accordance with one embodiment of the present invention.

FIG. 5 is a block diagram of a system for deploying a service in a cloud computing system, in accordance with one embodiment of the present invention.

### DETAILED DESCRIPTION

Embodiments will be described in more detail with reference to the accompanying drawings. However, the present disclosure can be implemented in various manners and thus should not be construed to be limited to the embodiments disclosed herein. The embodiments are provided for the thorough and complete understanding of the present disclosure, and for completely conveying the scope of the present disclosure to those skilled in the art.

It is understood that although this disclosure includes a detailed description on cloud computing, implementation of the teachings recited herein are not limited to a cloud computing environment. Embodiments of the present invention are capable of being implemented in conjunction with any other type of computing environment now known or later developed.

Cloud computing is a model of service delivery for enabling convenient and on-demand network access to a shared pool of configurable computing resources (e.g. networks, network bandwidth, servers, processing, memory, storage, applications, virtual machines, and services). The shared pool of configurable computing resources can be rapidly provisioned and released with minimal management effort or interaction with a provider of the service. This cloud model may include at least five characteristics, at least three service models, and at least four deployment models.

The at least five characteristics are as follows. (1) On-demand self-service. A cloud consumer can unilaterally provision computing capabilities as needed, such as server time and network storage, automatically without requiring human interaction with the service's provider. (2) Broad network access. Capabilities are available over a network and are accessed through standard mechanisms that promote use by heterogeneous thin or thick client platforms (e.g., mobile phones, laptops, and PDAs). (3) Resource pooling. The provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). (4) Rapid elasticity. Capabilities can be rapidly and elastically provisioned, in some cases automatically, to quickly scale out and rapidly release to quickly scale in. To the consumer, the capabilities available for provisioning often appear to be unlimited and can be purchased in any quantity at any time. (5) Measured service. Cloud systems automatically control and optimize resource use by leveraging a metering capability at some level of abstraction appropriate to the type of the service (e.g., storage, processing, bandwidth, and active user accounts). Resource usage can be monitored, controlled, and reported. Cloud systems provide transparency for both the provider and consumer of the utilized service.

The at least three service models are as follows. (1) Software as a Service (SaaS). The capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. (2) Platform as a Service (PaaS). The capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. (3) Infrastructure as a Service (IaaS). The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

The at least four deployment models are as follows. (1) Private cloud. The cloud infrastructure is operated solely for an organization. It may be managed by the organization or a third party and may exist on-premises or off-premises. (2) Community cloud. The cloud infrastructure is shared by several organizations and supports a specific community that has shared concerns (e.g., mission, security requirements, policy, and compliance considerations). It may be managed by the organizations or a third party and may exist on-premises or off-premises. (3) Public cloud. The cloud infrastructure is made available to the general public or a large industry group and is owned by an organization selling cloud services. (4) Hybrid cloud. The cloud infrastructure is a composition of two or more clouds (private, community, or public) that remain unique entities but are bound together by standardized or proprietary technology that enables data and application portability (e.g., cloud bursting for load-balancing between clouds).

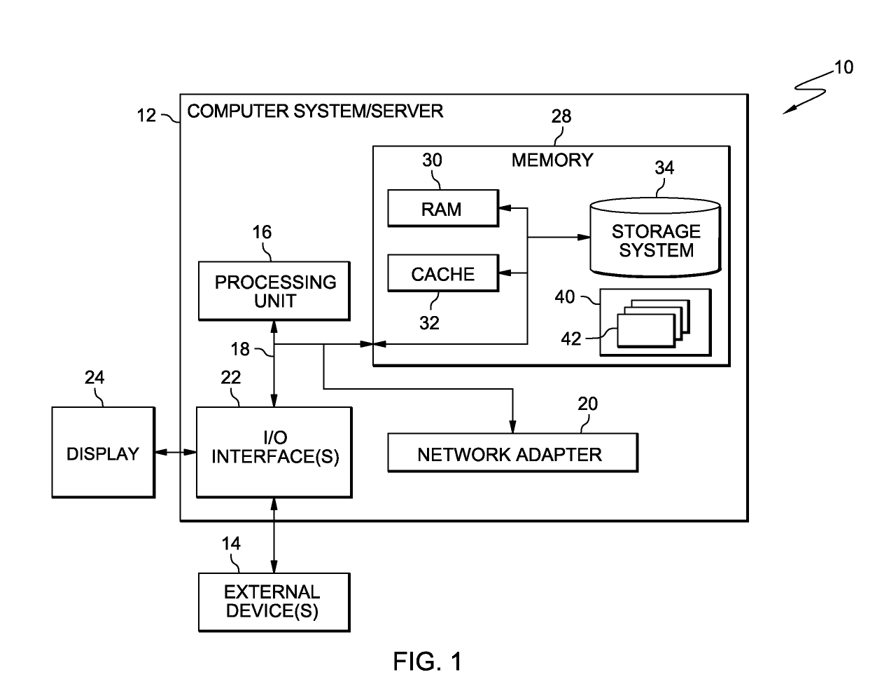

A cloud computing environment is service-oriented with a focus on statelessness, low coupling, modularity, and semantic interoperability. At the heart of cloud computing is an infrastructure comprising a network of interconnected nodes. FIG. 1 is a diagram illustrating cloud computing node 10, in accordance with one embodiment of the present invention. Cloud computing node 10 is only one example of a suitable cloud computing node and is not intended to suggest any limitation as to the scope of use or functionality of embodiments of the invention described herein. Cloud computing node 10 is capable of being implemented and/or performing any of the functionality set forth hereinabove.

In cloud computing node 10, there is computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and others that perform particular tasks or implement particular abstract data types. Computer system/server 12 may be practiced in distributed cloud computing environments where tasks are performed by remote processing devices that are linked through a network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 includes, but are not limited to, one or more processors or processing unit 16, system memory 28, and bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, including a set (at least one) of program modules 42, may be stored in memory 28 by way of example, and not limitation. Program/utility 40 may further include an operating system, one or more application programs, other program modules, and program data. The operating system, one or more application programs, other program modules, program data, or some combination thereof may include an implementation of a networking environment. Program modules 42 generally carry out the functions and/or methodologies of embodiments of the invention as described herein.

Computer system/server 12 communicates with one or more external devices 14, such as a keyboard, a pointing device, a display 24, etc. Computer system/server 12 may communicate with one or more devices that enable a user to interact with computer system/server 12. Computer system/server 12 may further communicate with any devices (e.g., network card, modem, etc.) that enable computer system/server 12 to communicate with one or more other computing devices. Such communications can occur via Input/Output (I/O) interface(s) 22. Furthermore, computer system/server 12 can communicate, via network adapter 20, with one or more networks such as a local area network (LAN), a general wide area network (WAN), and/or a public network (e.g., the Internet). As depicted, network adapter 20 communicates with the other components of computer system/server 12 via bus 18. It should be understood that although not shown, other hardware and/or software components can be used in conjunction with computer system/server 12. Examples of the other hardware and/or software components include, but are not limited to, microcode, device drivers, redundant processing units, external disk drive arrays, RAID (redundant array of inexpensive disks) systems, tape drives, and data archival storage systems, etc.

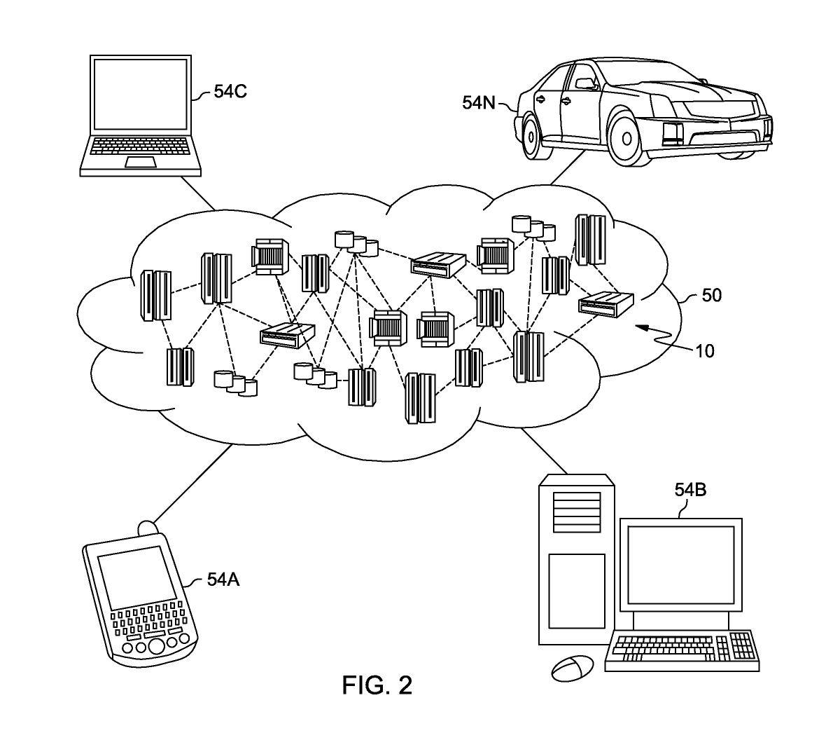

FIG. 2 is a diagram illustrating cloud computing environment 50, in accordance with one embodiment of the present invention. As shown in FIG. 2, cloud computing environment 50 comprises one or more cloud computing nodes 10 with which local computing devices used by cloud consumers. For example, personal digital assistant (PDA) or cellular telephone 54A, desktop computer 54B, laptop computer 54C, and/or automobile computer system 54N may communicate. One or more cloud computing nodes 10 communicate with each other. One or more cloud computing nodes 10 may be grouped (not shown) physically or virtually, in one or more networks, such as private, community, public, hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only, and it is also understood that computing nodes 10 and cloud computing environment 50 can communicate with any type of computerized devices over any type of network and/or network addressable connections (e.g., using a web browser).

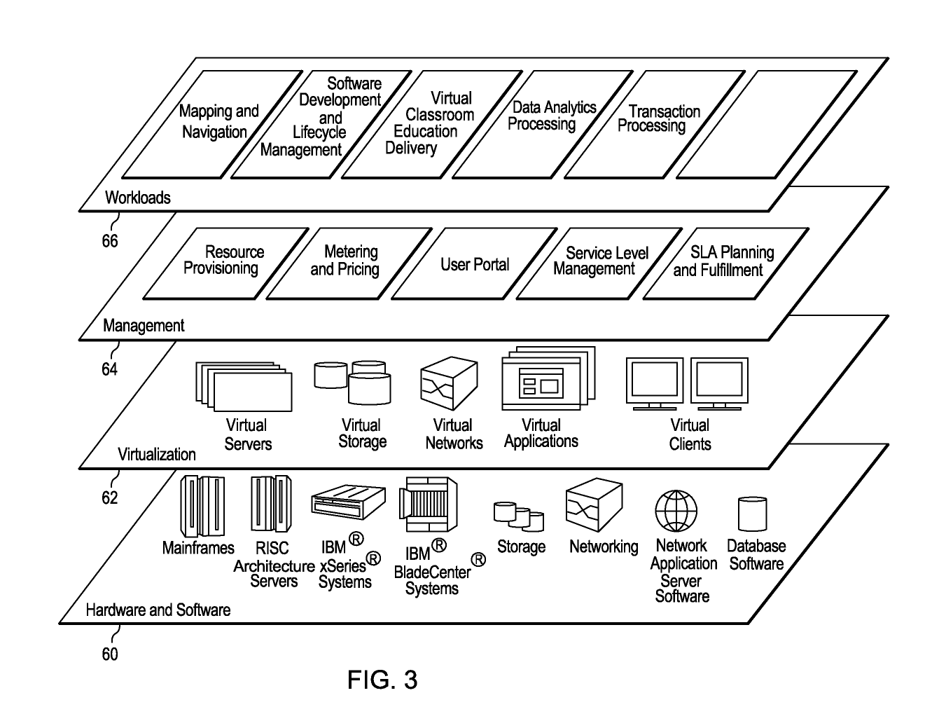

FIG. 3 is a diagram illustrating abstraction model layers (layers 60, 62, 64, and 66), in accordance with one embodiment of the present invention. Referring to FIG. 3, a set of functional abstraction layers provided by cloud computing environment 50 (shown in FIG. 2) is shown. It should be understood that the components, layers, and functions shown in FIG. 3 are intended to be illustrative only and embodiments of the invention are not limited thereto. As depicted, the following layers and corresponding functions are provided.

Referring to FIG. 3, hardware and software layer 60 includes hardware and software components. Examples of hardware components include mainframes, such as IBM® zSeries® systems; RISC (Reduced Instruction Set Computer) architecture based servers, such as IBM pSeries® systems; IBM xSeries® systems; IBM BladeCenter® systems; storage devices; networks and networking components. Examples of software components include network application server software, such as IBM WebSphere® application server software; and database software, such as IBM DB2® database software.

Referring to FIG. 3, virtualization layer 62 provides an abstraction layer from which the following examples of virtual entities may be provided: virtual servers; virtual storage; virtual networks, including virtual private networks; virtual applications and operating systems; and virtual clients.

Referring to FIG. 3, management layer 64 provides the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement and procurement of cloud computing resources, for which a future requirement is anticipated in accordance with an SLA.

Referring to FIG. 3, workloads layer 66 provides examples of functionality, which the cloud computing environment may be utilized. Examples of workloads and functions which may be provided from workloads layer 66 include: mapping and navigation, software development and lifecycle management, virtual classroom education delivery, data analytics processing, transaction processing, and others.

Servlet (a Java programming language class used to extend the capabilities of a server), EJB (server-side component architecture for modular construction of enterprise applications), web service, REST (Representational State Transfer, a way to create, read, update or delete information on a server), LDAP (Lightweight Directory Access Protocol, an application protocol for accessing and maintaining distributed directory information services over an Internet Protocol (IP) network), etc. are common in a cloud computing system. Service endpoints of these services are address for user to use the services, which typically include combination of IP addresses and ports of the services. A port of a service is typically only known by software itself. Although the port of the service is often only known by software itself, the service provided by the software usually satisfy current industry standards, such as Servlet, EJB, web service, REST, and LDAP.

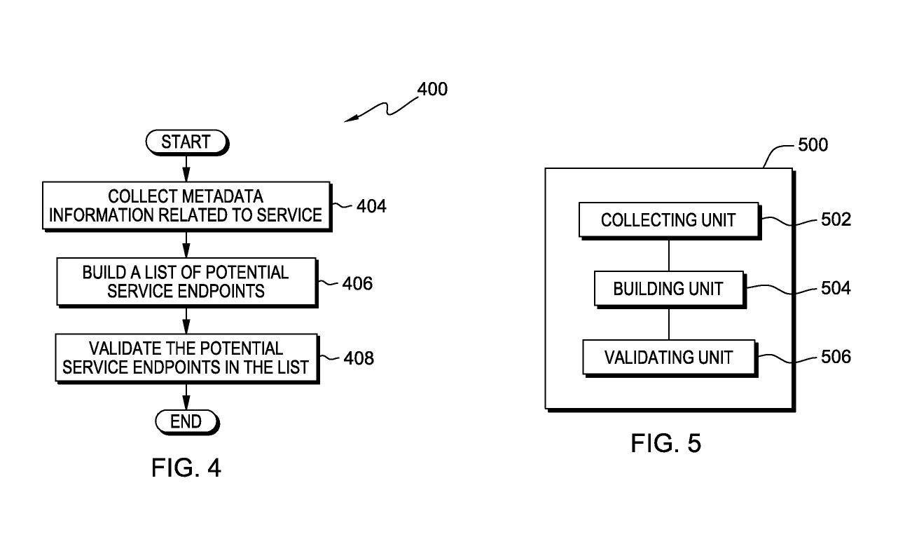

FIG. 4 is a diagram illustrating flowchart 400 for deploying a service in a cloud computing system, in accordance with one embodiment of the present invention. The specific implementation of embodiments of the invention is described below with reference to FIG. 4. The steps shown in flowchart 400 are implemented by system 500 (shown in FIG. 5) for deploying a service in a cloud computing system. At step 404, collecting unit 502 of system 500 collects metadata information related to the service. At step 406, building unit 504 of system 500 builds a list including a plurality of potential service endpoints by using the metadata information. At step 408, validating unit 506 of system 500 validates the potential service endpoints in the list.

The specific implementation of the embodiments of the invention is explained by taking a Servlet service as an example. The method, according to an embodiment of the invention, is performed at an initialization phase of the Servlet service lifecycle. As is well known, at the initialization phase of the Servlet service, Servlet instances are created according to Servlet configuration in a container configuration file while starting a Servlet container and initialization is conducted by invoking an initialization method init( ) of Servlet. According to an embodiment of the invention, codes are injected into the initialization method init( )for forming a collecting unit during initialization to collect metadata information related to the service. According to an embodiment of the invention, metadata information related to the service comprises IP address of the service and the port number of the service. According to an embodiment of the invention, metadata information related to the service comprises a service identifier and path. The service identifier may comprise the type of the service, the host name, and the process number. For the Servlet service, the type of the service is Servlet, the host name is a host to which the Servlet service is deployed, and the process number is a process number corresponding to the Servlet service on the host to which the Servlet service is deployed. The path is relative path of the Servlet service defined in the collecting unit. For example, the injected codes for forming the collecting unit during initialization may be as follows:

```
public class SEDetector extends HttpServlet{
  @Override
  public void init( ) throws ServletException {
    ServiceInfo si = collectServiceInfo ( );
    publishServiceInfo (si);
  }
  private ServiceInfo collectServiceInfo( ) {
    si.put(″service_type″,″servlet″);
    si.put(″hostname″, InetAddress.getLocalHost( ).getHostAddress( ));
    si.put(″context_path″,″http://{hostname}:
    {port}/servlet_service_validation″);
    si.put(″service_id″,″servlet″+ hostname +MBeanServer.getPID( ));
    if (si.port_list==null){
      currentServer = ManagementFactory.getRuntimeMXBean( );
      si.port_list=lsof(currentServer.getPID( ));
      }
      return si;
    }
    private void publishServiceInfo(ServiceInfo si){
      siAnalyzer.send(si);
    }
  }
```

Corresponding to the Servlet service, the collecting unit corresponds to standard HTTP Servlet; thus, the above codes will be injected into web.xml as following Servlet definition while deploying the Servlet service:

```
<?xml version=″1.0″encoding=″UTF-8″?>
<web-app id=″WebApp_ID″ version=″2.4″
        ...
<servlet>
        <servlet-name> SEDetector </servlet-name>
        <servlet-class>com.ibm.cloud. SEDetector </servlet-class>
        <load-on-startup>0</load-on-startup>
</servlet>
</web-app>
```

The formed collecting unit collects metadata information related to the service. The metadata information may comprises: (1) the type of the service, the host name, and the process number, combination of which is taken as the service identifier; (2) the IP address of the service; (3) the port number of the service; and (4) the relative path of the service.

For example, assuming the host to which the Servlet service is deployed is service.com.cn, the collected metadata information related to the service may be represented by Table 1.

TABLE 1

| Service | | Port | | | Process |
|---|---|---|---|---|---|
| identifier | IP address | No. | Relative path | Type | No. |
| Servlet_service.com.cn_91816 | 9.181.25.234 | 9080 | http://{hostname}:(port)/servlet_service_validation | Servlet | 91816 |
| | 172.16.254.1 | 2899 | | | |
| | . . . | 9060 | | | |
| | | . . . | | | |

Furthermore, codes are also injected into the initialization method init( )for forming a building unit during initialization to build a list of potential service endpoints by using the metadata information. A service endpoint typically includes combination of the IP address and the port of the service; thus, the building unit may build a list of potential service endpoints by combining the IP address and the port number of the service in the metadata information. For Example, the formed list may be represented by Table 2.

TABLE 2

| Service identifier | Service endpoint |
|---|---|
| Servlet_service.com.cn_91816 | 9.181.25.234:9080 |
| | 9.181.25.234:2899 |
| | 9.181.25.234:9060 |
| | 172.16.254.1:9080 |
| | 172.16.254.1:2899 |
| | 172.16.254.1:9060 |
| | . . . |

Furthermore, codes are also injected into the initialization method init( )for forming a validating unit during initialization to validate potential service endpoints. For example, the injected codes for forming the validating unit during initialization may be represented as follows:

```
public ServiceLocator{
  public void testService(ServiceInfo si){
    for(String str: si.getPorts( )){
      HttpClient httpClient = new HttpClient( );
      GetMethod getMethod =
      new
      GetMethod(″http://ip:port/context/validationhandshake″);
      Response res= client.executeMethod(getMethod);
      if (verifyResponse(res)){
        publishServiceLocation ( );
        return;
      }
    }
  public void publishServiceLocation( ){
    ...
  }
}
```

According to an embodiment of the invention, a validation request may be built up for each of potential service endpoints, and the validation request is published into the service for validation. Again taking the Servlet service as an example, a validation request built up for each of potential service endpoints may be represented in Table 3.

TABLE 3

| Service Identifier | Service endpoint | Validation request |
|---|---|---|
| Servlet_service.com.cn_91816 | 9.181.25.234:9080 | http://9.181.25.234:9080/servlet_service_validation |
| | 9.181.25.234:2899 | http://9.181.25.234:2899/servlet_service_validation |
| | 9.181.25.234:9060 | http://9.181.25.234:9060/servlet_service_validation |
| | 172.16.254.1:9080 | http://172.16.254.1:9080/servlet_service_validation |
| | 172.16.254.1:2899 | http://172.16.254.1:2899/servlet_service_validation |
| | 172.16.254.1:9060 | http://172.16.254.1:9060/servlet_service_validation |
| | . . . | |

Since a standard Servlet service has been injected by the collecting unit while deploying the Servlet service, according to an embodiment of the invention, the validating unit may validate potential service endpoints through handshake between the collecting unit and the validating unit. The validating unit may validate potential service endpoints by publishing the built validation request to the collecting unit and receiving result of validation. If the validation has been passed, then corresponding potential service endpoints are reserved. Then, according to an embodiment of the invention, deploying a service in a cloud computing system comprises a further step: registering potential service endpoint(s) passing the validation; at this step, potential service endpoint(s) passing the validation is/are registered with the cloud computing system. If the validation has not been passed, corresponding potential service endpoint(s) will be removed from the list.

Discussion of Table 3 is given as follows. As for validation request http://9.181.25.234:2899/servlet_service_validation, assuming this validation request returns HTTP 200 OK information, it means that validation has been passed, then corresponding service endpoint (9.181.25.234:289) is reserved. However, as for validation request http://9.181.25.234:9080/servlet_service_validation, it is published to the collecting unit, assuming this validation request returns HTTP 404 or 405 error information, it means that validation has not been passed, then its corresponding service endpoint (9.181.25.234:9080) is removed from the list. In this way, each of potential service endpoints may be validated by publishing all validation requests into the service. After validation, a final list of potential service endpoints is formed; the final list comprises all potential service endpoints passing the validation, mapping between services and service endpoints deployed in the cloud computing system.

For example, result returned by a validated service endpoint may be as follows.

```
{
  “name”: “servlet validation”,
  “validations”: [
      “ipAddress”: 9.181.25.234”,
      “port”: 2899
      “service Type”: “Servlet”,
        “isValidated″: “true”
    ]
}
```

For example, the final list of potential service endpoints may be as shown in Table 4.

TABLE 4

| Service identifier | Service endpoint |
|---|---|
| Servlet_service.com.cn_91816 | 9.181.25.234:2899 |
| | 172.16.254.1:9060 |

It should be appreciated that the validation of potential service endpoints through handshake described above is just an example of validating potential service endpoints. For different services, there are different corresponding methods for validating potential service endpoints, which can be derived by those skilled in the art based on the disclosure of the invention.

It should be appreciated that, the above description in conjunction with Servlet is merely for illustrative purpose and should not be regarded as a limitation to the protection scope of the invention. Those skilled in the art will appreciate that, for different services, codes for forming a collecting unit and for forming a validating unit may vary. For example, for EJB 3.0, the injected codes for forming a collecting unit during initialization may be as follows, for example:

```
public interface Validation {
  public boolean validate( );
}
@Stateful
@Remote ({Validation.class})
public class ValidationBean implements Validation {
  @Init
  public void init( ){
    ServiceInfo si = collectServiceInfo ( );
    publishServiceInfo (si); //This method is the same as
    that invoked in initialization method in Servlet for
    collecting list of possible endpoints.
  }
  public boolean validate( ){
  return true;
  }
}
```

For example, assuming that the host to which EJB service is deployed is also service.com.cn, the collected metadata information related to the service may be represented by Table 5.

TABLE 5

| | | Port | | | Process |
|---|---|---|---|---|---|
| Service Identifier | IP address | No. | Relative path | Type | No. |
| EJB_service.com.cn_91816 | 9.181.25.234 | 9080 | iiop://{hostname}:(port)/validation | EJB | 91816 |
| | 172.16.254.1 | 2899 | | | |
| | . . . | 9060 | | | |
| | | . . . | | | |

For example, the injected codes for forming a validating unit during initialization may be as follows:

```
public ServiceLocator{
    public void testService(ServiceInfo si){
      try{
  Properties props=new Properties( );
  props.put(Context.PROVIDER_URL,″ iiop://ip:port/NameService″);
  Context context = new InitialContext(props);
      Validation validator = (Validation) context.lookup(″Validation″);
        Boolean successful = validator.validate( );
        if (successful) {
          publishServiceLocation ( );
        return;
      }
      catch(Exception ex){
        out.println(ex.getMessage( ));
      }
}
```

FIG. 5 is a block diagram of system 500 for deploying a service in a cloud computing system, in accordance with one embodiment of the present invention. System 500 comprises collecting unit 502 configured to collect metadata information related to the service, building unit 504 configured to build a list including a plurality of potential service endpoints by using the metadata information, and validating unit 506 configured to validate the potential service endpoints in the list. According to an embodiment of the invention, collecting unit 502 is configured to collect metadata information related to the service at a service initialization phase. According to an embodiment of the invention, the metadata information related to the service comprises the IP address of the service and the port number of the service. According to an embodiment of the invention, the metadata information related to the service comprises the service identifier and path. According to an embodiment of the invention, the service identifier may comprise the type of the service, the host name, and the process number.

According to an embodiment of the invention, validating unit 506 is further configured to build a validation request for each of the potential service endpoints and to publish the validation request into the service for validation.

According to an embodiment of the invention, system 500 further comprises a receiving unit (not shown in FIG. 5) configured to receive result of the validation and a removing unit (not shown in FIG. 5) configured to remove potential service endpoint(s) not passing the validation from the list.

According to an embodiment of the invention, system 500 further comprises a registering unit (not shown in FIG. 5) configured to register potential service endpoint(s) passing the validation.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for deploying a service in a cloud computing system, comprising:
collecting metadata information related to the service;
building a list including a plurality of potential service endpoints by using the metadata information; and
validating the potential service endpoints in the list.

2. The method of claim 1, wherein the step of collecting metadata information related to the service is performed at a service initialization phase.

3. The method of claim 1, wherein the step of validating the potential service endpoints in the list comprises:
building a validation request for each of the potential service endpoints; and
publishing the validation request into the service for validation.

4. The method of claim 3, further comprising:
receiving result of the validation; and
registering potential service endpoints that pass the validation.

5. The method of claim 4, further comprising:
removing, from the list, potential service endpoints that do not pass the validation.

6. The method of claim 1, wherein the step of building the list further comprises:
combining an IP address of the service and a port number of the service to build the list.

7. The method of claim 1, wherein the metadata information related to the service comprises an IP address of the service and a port number of the service.

8. A system for deploying a service in a cloud computing system, comprising:
a collecting unit configured to collect metadata information related to the service;
a building unit configured to build a list including a plurality of potential service endpoints by using the metadata information;
a validating unit configured to validate the potential service endpoints in the list.

9. The system of claim 8, wherein the collecting unit is configured to collect the metadata information related to the service at a service initialization phase.

10. The system of claim 8, wherein the validating unit is further configured to:
build a validation request for each of the potential service endpoints; and
publish the validation request into the service for validation.

11. The system of claim 8, the validating unit further comprising:
a receiving unit configured to receive result of validation; and
a registering unit configured to register potential service endpoints that pass the validation.

12. The system of claim 8, the validating unit further comprising:
a removing unit configured to remove, from the list, potential service endpoints that do not pass validation.

13. The system of claim 8, the building unit is further configured to combine an IP address of the service and a port number of the service to build the list.

14. The system of claim 8, wherein the metadata information related to the service comprises an IP address of the service and a port number of the service.
